(19) United States
(12) Patent Application Publication
(10) Pub. No.: US 2007/0147654 A1
(43) Pub. Date: Jun. 28, 2007

(54) System and method for translating text to images

(75) Inventors: Paul Clatworthy, Los Gatos, CA (US); Sally Walsh, Los Gatos, CA (US); Raymond Walsh, Los Gatos, CA (US)

Correspondence Address: THELEN REID BROWN RAYSMAN & STEINER LLP, 2225 EAST BAYSHORE ROAD, SUITE 210, PALO ALTO, CA, 94303, US

(73) Assignee: Power Production Software

(21) Appl. No.: 11/432,204

(22) Filed: May 10, 2006

Related U.S. Application Data
(60) Provisional application No. 60/597,739, filed on Dec. 18, 2005.
(60) Provisional application No. 60/794,213, filed on Apr. 21, 2006.

(51) Int. Cl. G06K 9/00

(52) U.S. Cl. 382/100

(57) ABSTRACT

A method comprises receiving input text; decomposing the input text into segments, e.g., single line segments; using a dictionary to identify at least one object in one of the segments for inclusion in a frame; and using cinematic conventions, e.g., proxemics, to arrange the at least one object in the frame. The input text may be received via a keyboard, via a disk drive, or via a network interface. The dictionary may include a slug line dictionary, a character dictionary, a prop dictionary, an action dictionary, an environment dictionary, etc. The method may further comprise determining the relative importance of the at least one object, and positioning the at least one object in the frame based on its relative importance. The method may further comprise analyzing a segment adjacent to the one of the segments to determine relevant objects for the one of the segments.

### PRIORITY CLAIM

This application claims benefit of and hereby incorporates by reference provisional patent application Ser. No. 60/597,739, entitled “Software System and Method for Translating Text to Images,” filed on Dec. 18, 2005, by inventor Paul Clatworthy, Raymond Walsh and Sally Walsh; and provisional patent application Ser. No. 60/794,213, entitled “System, Method and Program for Conversion of Text to Cinematic Images,” filed on Apr. 21, 2006, by inventor Paul Clatworthy and Sally Walsh.

### TECHNICAL FIELD

This invention relates generally to a system and method for converting text to images, and more particularly to a system and method for converting text to cinematic proxemic imagery with beta movement.

### BACKGROUND

In film and other creative industries, storyboards are a series of drawings used in the pre-visualization of a live action or an animated film (including movies, television, commercials, animations, games, technical training projects, etc.). Storyboards provide a visual representation of the composition and spatial relationship of background, characters and objects to each other within a shot or scene.

Cinematic images for a live action film were traditionally generated by narrative scene acted out by actors portraying characters from a screenplay. In the case of an animated film, the settings and characters making up the cinematic images were drawn by an artist. More recently, computer 2D and 3D animation tools have replaced hand drawings. With the advent of computer software such as Storyboard Quick and Storyboard Artist by PowerProduction Software, a person with little to no drawing skills is now be capable of generating computer-rendered storyboards for a variety of visual projects.

Generally, each storyboard frame represents a shot-size segment of a film. In the film industry, a “shot” is defined as a single, uninterrupted roll of the camera. Multiple shots are edited together to form a “scene” or “sequence.” A “scene” or “sequence” is defined as a segment of a screenplay acted out in a single location. A completed screenplay or film is made up of series of scenes, and therefore many shots.

By skillful use of shot size, element placement and cinematic composition, storyboards can convey a story in a sequential manner and help to enhance emotional and other non-verbal information cinematically. Typically, a director, auteur and/or cinematographer controls the content and flow of a visual plot as defined by the script or screenplay. To facilitate telling the story and bend an audience's emotional response, the director, auteur and/or cinematographer may employ cinematic conventions such as:
Establishing shot: typically used at a new location to give an audience a sense of time and locality.
Long shot: shows a scene from a distance (not as far as an establishing shot).
Close-ups: to show tension by focusing on a character's reaction. The subject of the close-up usually fills the frame.
Extreme close-ups: A single element of the larger item, e.g., a facial feature of a face, typically fills the frame.
Medium shot: (of a character) usually a waist-high “single” covering one character, but can be a group shot, two-shot (i.e., a shot with two people in it), over-the-shoulder shot or other shot that frames the image and appears “normal” to the human eye.

To indicate object movement or camera movement in the shot or scene, storyboards may use arrows. Alternatively, animatic storyboards may be used. Animatic storyboards include conventional storyboard frames that are presented sequentially to show motion. Animatic storyboards may use in-frame movement and/or between-frame transitions and may include sound and music.

Generating a storyboard frame is a time-consuming process of designing, drawing or selecting images, positioning elements into a frame, sizing elements individually, etc. The quality of each resulting cinematic shot depends on the user's drawing skills, knowledge, experience and ability to make creative interpretative decisions about a script. A system and method that assists with and/or automates the generation of cinematic shots are needed.

### SUMMARY

An embodiment of the present invention enables automatic translation of natural language, narrative text (e.g., script, story, dialogue, a chat-room text, etc.) into a series of sequential frames and/or cinematic shots (e.g., animatics, animation, motion picture, etc.) by means of a computer program. One embodiment provides a computer-assisted system, method and/or computer program product for translating natural language text into a series of frames or shots that portray spatial relationships between characters, locations, props, etc. based on proxemic, cinematic narrative structures and conventions. The storyboard frames may combine digital still images and/or digital motion picture images of locations, characters, props, etc. from a predefined and customizable library into layered cinematic compositions. Each element, as defined by a location, character, prop or other object, can be moved and otherwise independently customized. The resulting frames can be rendered as a series of digital still images or as a digital motion picture with sound, conveying the context, emotion and story of the entered and/or imported text.

One embodiment may assist with the automation of visual literacy and storytelling. Another embodiment may save time and energy for those beginning the narrative story pre-visualizing and visualizing process. Yet another embodiment may enable the creation of frames and/or shots which can be further customized. Still another embodiment may assist teachers trying to teach students the language of cinema. Another embodiment may simulate a director's process of analyzing and visualizing a screenplay or other narrative text into various frames and/or shots.

In one embodiment, the present invention provides a system comprising an input device for receiving input text; a text decomposition module for decomposing the input text into segments; a segment analysis module for using a dictionary to identify at least one object in one of the segments for inclusion in a frame; and a cinematic frame arrangement module for using cinematic conventions to arrange the at least one object in the frame. The input device may include a keyboard, a disk drive, or a network interface. The text decomposition module may decompose the input text into single line segments. The dictionary may include a slug line dictionary and the at least one object may include environment information. The dictionary may include a character dictionary and the at least one object may include a character. The dictionary may include a prop dictionary and the at least one object may include a prop. The segment analysis module may determine the relative importance of the at least one object, and the cinematic frame arrangement module may position the at least one object based on its relative importance. The segment analysis module may review a segment adjacent to the one of the segments to determine relevant objects for the one of the segments.

In another embodiment, the present invention provides a method comprising receiving input text; decomposing the input text into segments; using a dictionary to identify at least one object in one of the segments for inclusion in a frame; and using cinematic conventions to arrange the at least one object in the frame. The input text may be received via a keyboard, via a disk drive, or via a network interface. The segments may include single line segments. The dictionary may include a slug line dictionary and the at least one object may include environment information. The dictionary may include a character dictionary and the at least one object may include a character. The dictionary may include a prop dictionary and the at least one object may include a prop. The method may further comprise determining the relative importance of the at least one object, and positioning the at least one object in the frame based on its relative importance. The method may further comprise analyzing a segment adjacent to the one of the segments to determine relevant objects for the one of the segments.

In yet another embodiment, the present invention provides a system comprising means for receiving input text; means for decomposing the input text into segments; means for using a dictionary to identify at least one object in one of the segments for inclusion in a frame; and means for using cinematic conventions to arrange the at least one object in the frame.

### BRIEF DESCRIPTION OF THE DRAWINGS

FIG. 1A is a block diagram of a computer having a cinematic frame creation system, in accordance with an embodiment of the present invention.

FIG. 2 is a block diagram of a computer network having a cinematic frame creation system, in accordance with an embodiment of the present invention.

FIG. 3 is a block diagram illustrating details of the cinematic frame creation system, in accordance with an embodiment of the present invention.

FIG. 4 is a block diagram illustrating details of the segment analysis module, in accordance with an embodiment of the present invention.

FIG. 5 is a flowchart illustrating a method of converting text to cinematic images, in accordance with an embodiment of the present invention.

FIG. 6 is a flowchart illustrating a method of searching story scope data and generating a shot array memory, in accordance with an embodiment of the present invention.

FIG. 7 illustrates an example script text file.

FIG. 8 illustrates an example formatted script text file.

FIG. 9 illustrates an example of an assembled frame generated by the cinematic frame creation system, in accordance with an embodiment of the present invention.

FIG. 10 is an example series of frames generated by the cinematic frame creation system using a custom database of character images and backgrounds, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

An embodiment of the present invention enables automatic translation of natural language, narrative text (e.g., script, a chat-room dialogue, etc.) into a series of sequential storyboard frames and/or storyboard shots (e.g., animatics) by means of a computer program. One embodiment provides a computer-assisted system, method and/or computer program product for translating natural language text into a series of frames or shots that portray spatial relationships between characters, locations, props, etc. based on proxemic, cinematic narrative structures and conventions. The storyboard frames may combine digital still images and/or digital motion picture images of locations, characters, props, etc. from a predefined and customizable library into layered cinematic compositions. Each element, as defined by a location, character, prop or other object, can be moved and otherwise independently customized. The resulting frames can be rendered as a series of digital still images or as a digital motion picture with sound, conveying the context, emotion and story of the entered and/or imported text. The text can also be translated to speech sound files and added to the motion picture with the length of the sounds used to determine the length of time a particular shot is displayed.

One embodiment may assist with the automation of visual literacy and storytelling. Another embodiment may save time and energy for those beginning the narrative story pre-visualizing and visualizing process. Yet another embodiment may enable the creation of frames and/or shots which can be further customized. Still another embodiment may assist teachers trying to teach students the language of cinema. Another embodiment may simulate a director's process of analyzing and visualizing a screenplay or other narrative text into various frames and/or shots.

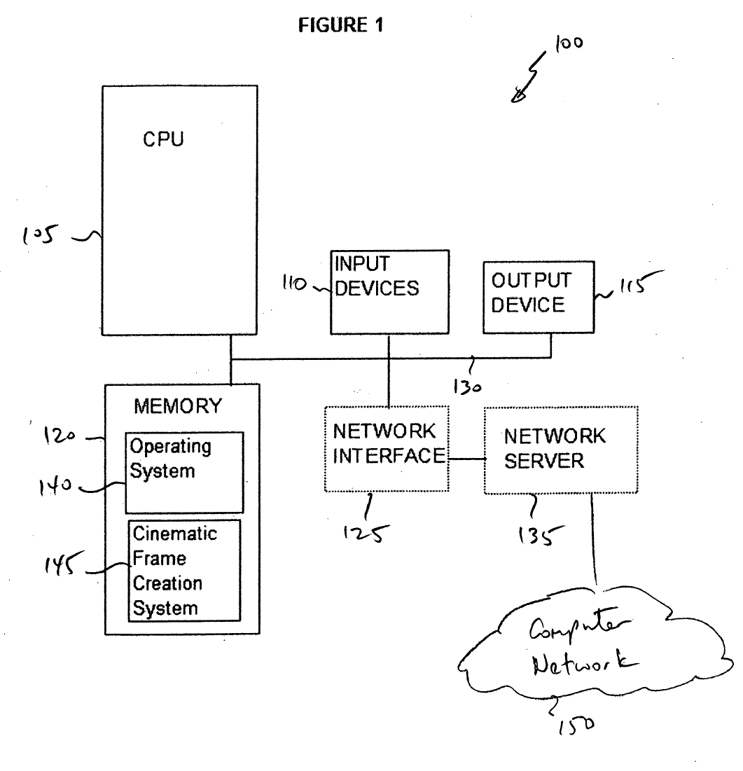

FIG. 1 is a block diagram of a computer 100 having a cinematic frame creation system 100, in accordance with an embodiment of the present invention. As shown, the cinematic frame creation system 100 may be a stand-alone application. Computer 100 includes a central processing unit (CPU) 105 (such as an Intel Pentium® microprocessor or a Motorola Power PC® microprocessor), an input device 110 (such as a keyboard, mouse, scanner, disk drive, electronic fax, USB port, etc.), an output device 115 (such as a display, printer, fax, etc.), a memory 120, and a network interface 125, each coupled to a computer bus 130. The network interface 125 may be coupled to a network server 135, which provides access to a computer network 150 such as the wide-area network commonly referred to as the Internet. Memory 120 stores an operating system 140 (such as the Microsoft Windows XP, Linux, the IBM OS/2 operating system, the MAC OS, or UNIX operating system) and the cinematic frame creation system 145. The cinematic frame creation system 145 may be written using JAVA, XML, C++ and/or other computer languages, possibly using object oriented programming methodology. It will be appreciated that the term “memory” herein is intended to cover all data storage media whether permanent or temporary.

The cinematic frame creation system 145 may receive input text (e.g., script, descriptive text, a book, and/or written dialogue) from input device 110, from the computer network 150, etc. For example, the cinematic frame creation system 145 may receive a text file downloaded from a disk, typed into the keyboard, downloaded from the computer network 150, received from an instant messaging session, etc. The text file can be imported or typed into designated text areas. In one embodiment, a text file or a screenplay-formatted file such as .FCF, .TAG or .TXT can be imported into the system 145.

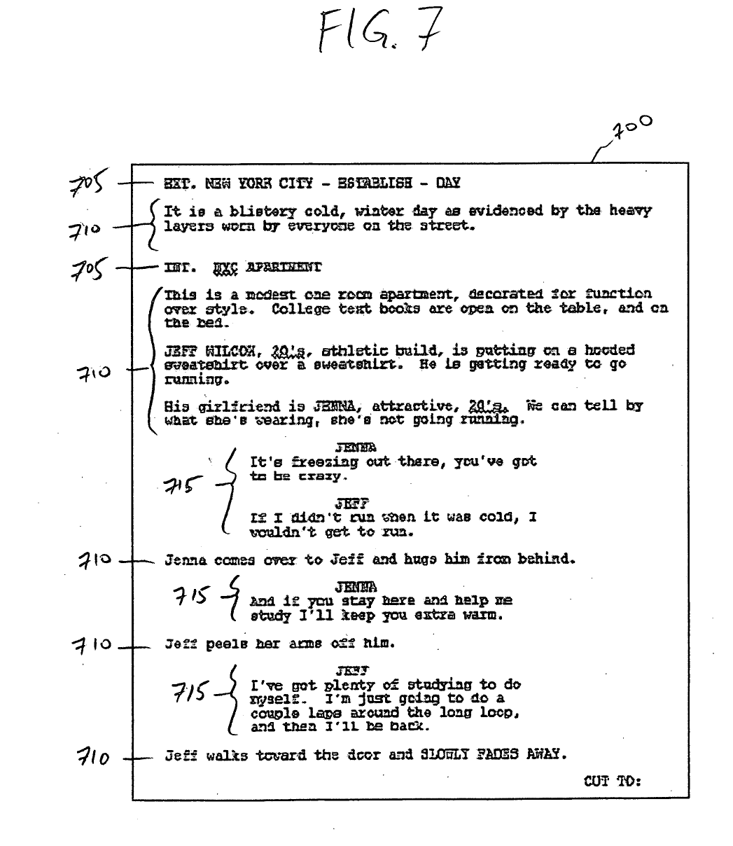

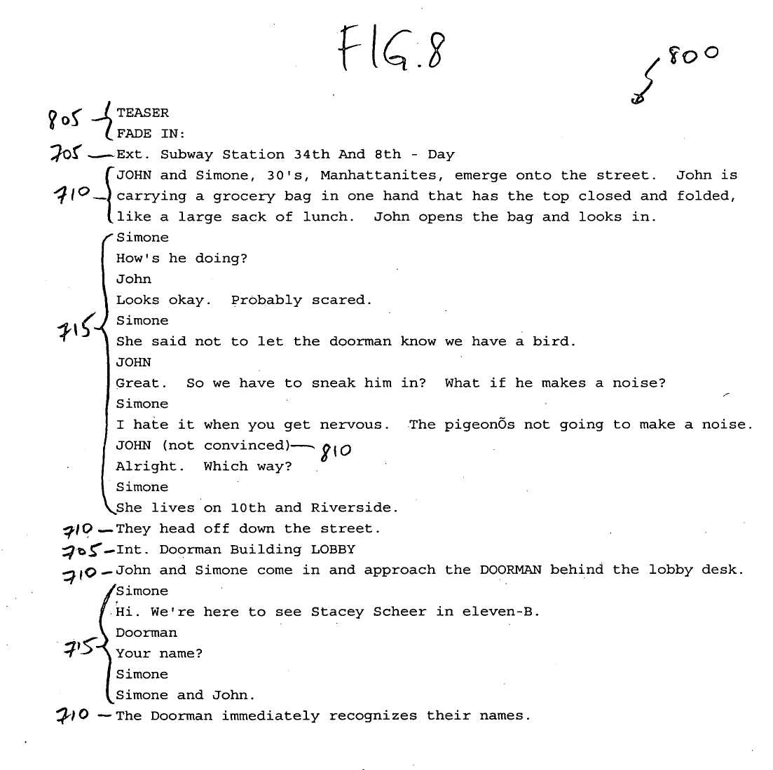

Examples texts that can be input into the cinematic frame creation system 145 are shown in FIGS. 7 and 8. FIG. 7 illustrates an example script-format text file 700. Script-format text file 700 includes slug lines 705, scene descriptions 710, and character dialogue 715. FIG. 8 illustrates another example script-formatted text file 800. Text file 800 includes scene introduction/conclusion text 805 (keywords to indicate a new scene is beginning or ending), slug lines 705, scene descriptions 710, character dialogue 715, and parentheticals 810. A slug line 705 is a cinematic tool indicating generally location and/or time. In a screenplay format, an example slug line is “INT. CITY HALL-DAY.” Introduction/conclusion text 805 includes commonly used keywords such as “FADE IN” to indicate the beginning of a new scene or commonly used keywords such as “FADE OUT” to indicate the ending of a scene. A scene description 710 is non-dialogue text describing character information, action information and/or other scene information. A parenthetical 810 is typically scene information offset by parentheses. It will be appreciated that scene descriptions 710 and parentheticals 810 are similar, except that scene descriptions 710 typically do not have a character identifier nearby and parentheticals 710 are typically surrounded by parentheses.

The cinematic frame creation system 145 may translate received text into a series of frames and/or shots that represents the narrative structure and conveys the story. The cinematic frame creation system 145 applies cinematic (visual storytelling) conventions to place, size and position elements into sequential frames. The series can also be re-arranged, shots deleted and added and edited. The series of rendered frames can be displayed on the output device 115, saved to a file in memory 120, printed to output device 115, exported to other formats (streaming video, QuickTime Movie or AVI file), and/or exported to other devices such as another program or computer (e.g., for editing).

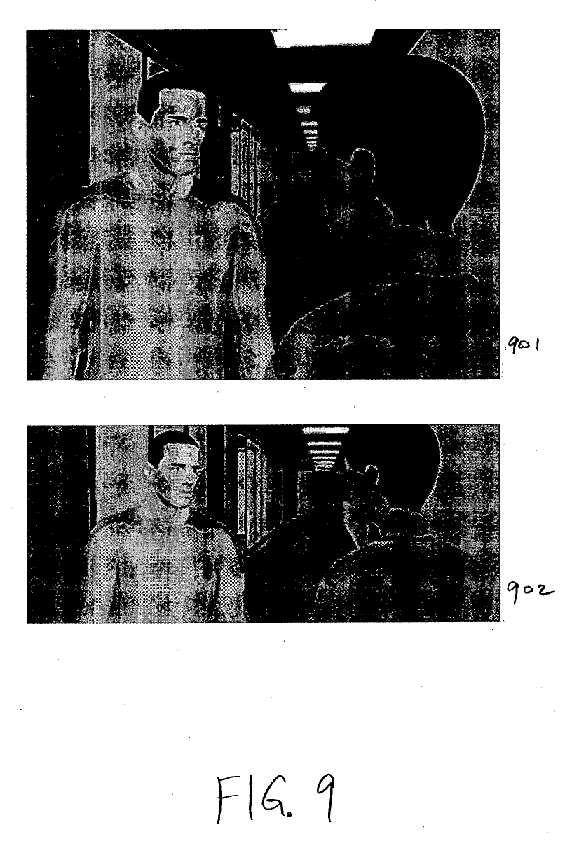

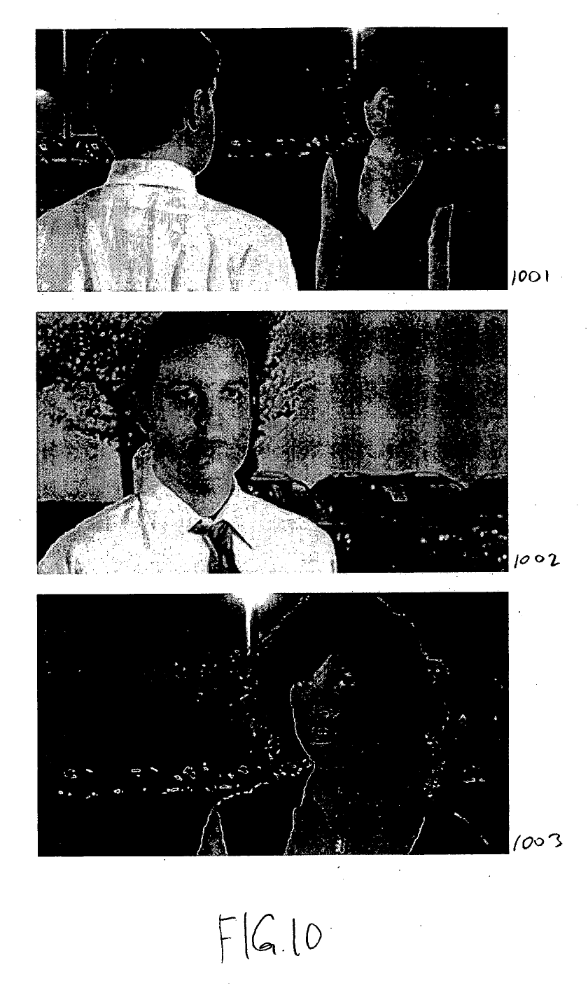

Examples of frames generated by the cinematic frame creation system 145 are shown in FIGS. 9 and 10. FIG. 9 illustrates two example assembled frames generated by the cinematic frame creation system 145, in accordance with two embodiments of the present invention. The first frame 901 is a two-shot and an over-the-shoulder shot and was created for a Television aspect ratio (1.33). The second frame 902 includes the same content (a two-shot and an over-the-shoulder shot) but object placement is adjusted for a wide-screen format. The second frame 902 has less headroom and a wider background is visible than the first frame 901. In both frames 901 and 902, the characters are distributed in cinematically pleasing composition based on variety of cinematic conventions mentioned above, e.g., headroom, ground space, horizon, edging, etc. FIG. 10 is an example series of three frames 1001, 1002 and 1003 generated by the cinematic frame creation system 145 using a custom database of character renderings and backgrounds, in accordance with an embodiment of the present invention.

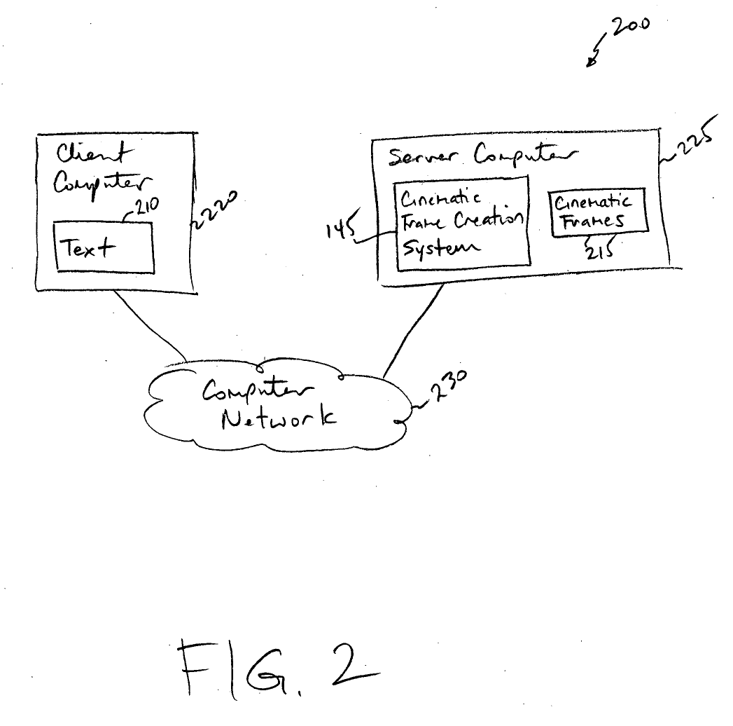

FIG. 2 is a block diagram of a computer network 200 having a cinematic frame creation system 145, in accordance with a distributed embodiment of the present invention. The computer network 200 includes a client computer 220 coupled via a computer network 230 to a server computer 225. As shown, the cinematic frame creation system 145 is located on the server computer 225, may receive text 210 from the client computer 220, and may generate the cinematic frames 215 which can be forwarded to the client computer 220. Other distributed environments are also possible.

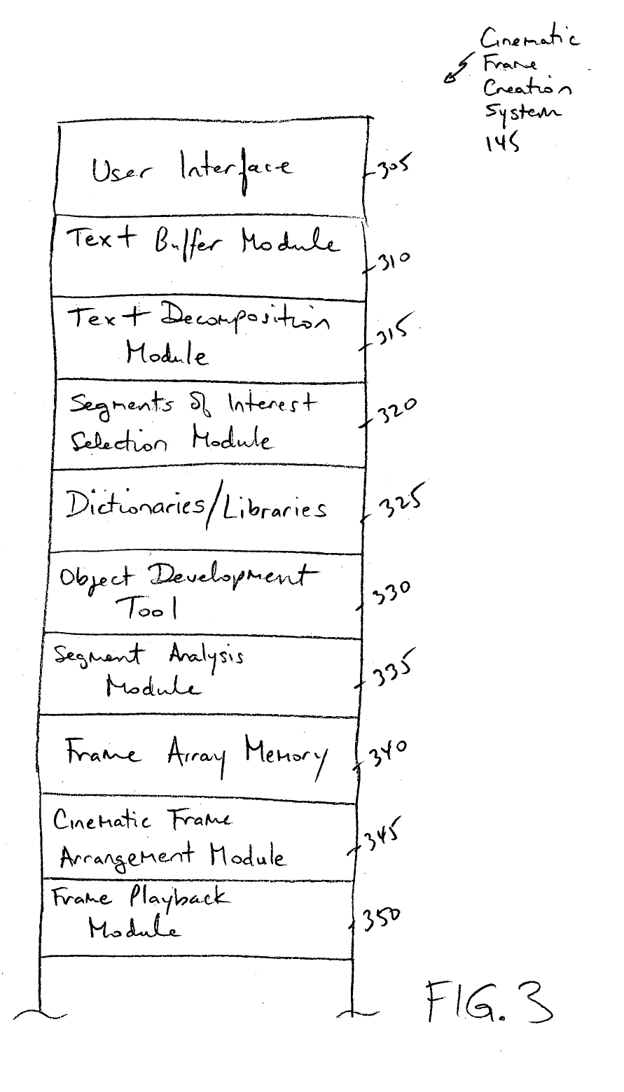

FIG. 3 is a block diagram illustrating details of the cinematic frame creation system 145, in accordance with an embodiment of the present invention. Cinematic frame creation system 145 includes a user interface 305, a text buffer module 310, a text decomposition module 315, a segments-of-interest selection module 320, dictionaries/libraries 325, an object development tool 330, a segment analysis module 335, a frame array memory 340, a cinematic frame arrangement module 345, and a frame playback module 350.

The user interface 305 includes a user interface that enables user input of text, user input and/or modification of objects (character names and renderings, environment names and renderings, prop names and renderings, etc.), user modification of resulting frames, user selection of a frame size or aspect ratio (e.g., TV aspect, US Film, European Film, HDTV, Computer Screen, 16 mm, etc.), etc.

The text buffer module 310 includes memory for storing text received for frame creation. The text buffer module 310 may include RAM, Flash memory, portable memory, permanent memory, disk storage, and/or the like. The text buffer module 310 includes hardware, software and/or firmware that enable retrieving text lines/segments/etc. for feeding to the other modules, e.g., the segment analysis module 335.

The text decomposition module 315 includes hardware, software and/or firmware that enable automatic or assisted decomposition of a text into a set of segments, e.g., single line portions, sentence size portions, shot-size portions, scene-size portions, etc. To conduct segmentation, the text decomposition module 315 may review character names, character genders (e.g., Lady #1, Boy #2, etc.), slug lines, sentence counts, verbs, punctuation, keywords and/or other criteria. The text decomposition module 315 may search for changes of location, changes of scene information, changes of character names, etc. In one example, the text decomposition module 315 labels each segment by sequential numbers for ease of identification.

Using script text 700 of FIG. 7 as an example, the text decomposition module 315 may decompose the script text 700 into a first segment including the slug line 705, a second segment including the first scene description 710, a third segment including the second slug line 705, a fourth segment including the first sentence of the first paragraph of the second scene description 710, etc. Each character name may be a single segment. Each statement made by each character may be a single segment. The text decomposition module 315 may decompose the text in various other ways.

The segments-of-interest selection module 320 includes hardware, software and/or firmware that enables selection of a sequence of segments of interest for frame creation. The user may select frames by selecting a set of segment numbers, whether sequential or not. The user may be given a range of numbers (from x to n: the number of segments found during the text decomposition) and location names, if available. The user may enter a sequential range of segment numbers of interest for the frames and/or shots they want to create.

The dictionaries/libraries 325 include the character names, prop names, environment names, generic character identifiers, and/or other object names and include their graphical renderings, e.g., avatars, object images, background images, etc. For a character, the object name may include descriptors like “Jeff,” “Jenna,” “John,” “Simone”, etc. For a prop, the object name may include descriptors like “ball,” “car,” “bat,” “toy,” etc. For generic character identifiers, the object name may include descriptors like “Lady #1,” “Boy #2,” “Policeman #1,” etc. For an environment, an environment name may include descriptors, like “in the park,” “at home,” “bus station,” “NYC,” etc. For a character name or generic character identifier, the graphical renderings may include a set of animated, 3-D, moving, standard or customized images, each image possibly showing the person in a different position or performing a different action (e.g., sitting, standing, bending, lying down, jumping, running, sleeping, etc.), from different angles. For a prop, the graphical renderings may include a set of animated, 3-D, moving, standard or customized images, each image possibly showing the prop from a different angle. For an environment, the graphical renderings may include a set of animated, 3-D, moving, standard or customized images. The set of location images may include the possible locations at various times, various amounts of lighting, various levels of detail, various distances, etc.

In one embodiment, the dictionary includes a list of possible object names (including proper names and generic names), each with a field for a link to a graphical rendering in the library, and the library includes the graphical renderings. The associated graphical renderings may comprise generic images of men, generic images of women, generic images of props, generic backgrounds, etc. Even though there may be thousands of names to identify a boy, the library may contain a smaller number of graphical renderings for a boy. The fields in the dictionary may be populated during segment analysis to link the objects (e.g., characters, backgrounds, props, etc.) in the text to graphical renderings in the library.

In one embodiment, the dictionaries 325 may be XML lists of stored data. Their “meanings” may be defined by images or multiple image paths. These dictionaries 325 can grow by user input, customization or automatically.

The object development tool 330 includes hardware, software and/or firmware that enables a user to create and/or modify object names, graphical renderings, and the association of names with graphical renderings. A user may create an object name and an associated customized graphical renderings for each character, each location, each prop, etc. The graphical renderings may be animated, digital photographs, blends of animation, 3-D, moving pictures and digital photographs, etc. The object development tool 330 may include drawing tools, photography tools, 3D rendering tools, etc.

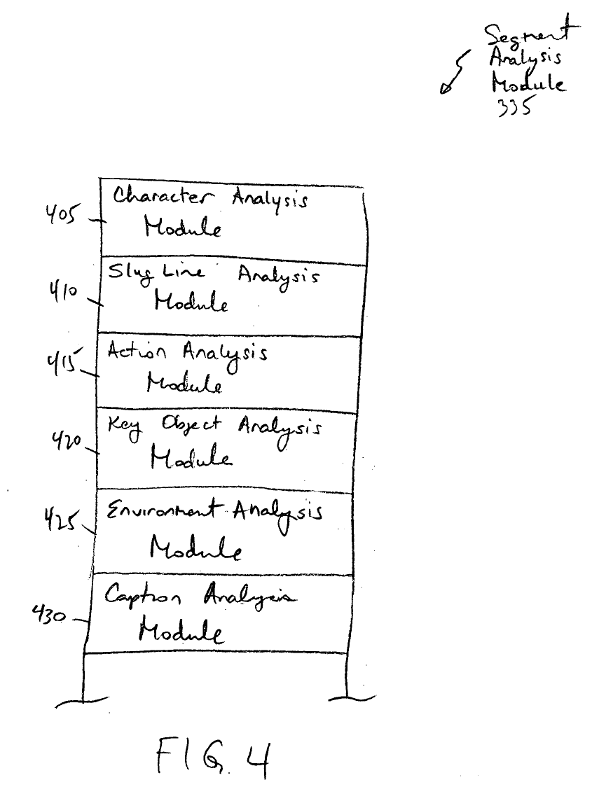

The segment analysis module 335 includes hardware, software and/or firmware that determine relevant elements in the segment, (e.g., objects, actions, object importance, etc.). Generally, the segment analysis module 335 uses the dictionaries/libraries 325 and cinematic conventions to analyze a segment of interest in the text to determine relevant elements in the segment. The segment analysis module 335 may review adjacent and/or other segments to maintain cinematic consistency between frames. The segment analysis module 335 populates fields to link the objects identified with specific graphical renderings. The segment analysis module 335 stores the relevant frame elements for each segment in a frame array memory 340. The details of the segment analysis module are 335 described with reference to FIG. 4.

The cinematic frame arrangement module 345 includes hardware, software and/or firmware that uses cinematic conventions to arrange the frame objects associated with the segment and/or segments of interest. The cinematic frame arrangement module 345 determines whether to generate a single frame for a single segment, multiple frames for a single segment, or a single frame for multiple segments. This determination may be based on information provided by the segment analysis module 335.

In one embodiment, the cinematic frame arrangement module 345 first determines the frame size selected by the user. Using cinematic conventions, the cinematic frame arrangement module 345 sizes, positions and layers the frame objects individually to the frame. Some example of cinematic conventions that the cinematic frame arrangement module 345 may employ include:
Strong characters appear on right side of screen making that section of the screen a strong focal point.
Use rule of thirds; don't center a character.
Close-ups involve viewers emotionally.
Foreground elements are more dominant that background elements.
Natural and positive movement is perceived as being from left to right.
Movement catches the eye.
Text in a scene pulls the eye toward it.
Balance headroom, ground space, third lines, horizon lines, frame edging, etc.

The cinematic frame arrangement module 345 places the background environment into the chosen frame aspect. The cinematic frame arrangement module 345 positions and sizes the background environment into the frame based on its significance to the other frame objects and to the cinematic scene or collection of shots with the same or similar background image. The cinematic frame arrangement module 345 may place and size the background environment to fill the frame or so that only a portion of the background environment is visible. The cinematic frame arrangement module 345 may use an establishing shot rendering from the set of graphical renderings for the environment. According to one convention, if the text continues for several lines and no characters are mentioned, the environment may be determined to be an establishing shot. The cinematic frame arrangement module 345 may select the angle, distance, level of detail, etc. based on keywords noted in the text, based on backgrounds of adjacent frames, based on other factors.

The cinematic frame arrangement module 345 may determine character placement based on data indicating who is talking to whom, who is listening, the number of characters in the shot, information from the adjacent segments, how many frame objects are in frame, etc. The cinematic frame arrangement module 345 may assign an importance value to each character and/or object in the frame. For example, unless otherwise indicated by the text, a speaking character is typically given prominence. Each object may be placed into the frame according to its importance to the segment.

The cinematic frame arrangement module 345 may set the stageline between characters in the frames based on the first shot of an action sequence with characters. A stageline is an imaginary line between characters in the shot. Typically, the camera view stays on one side of the stageline, unless specific cinematic conventions are used to cross the line. Maintaining a consistent stageline helps to alleviate a “jump cut” between shots. A jump cut is when a character appears to “jump” or “pop” across a stageline in successive shots. Preserving the stageline in the scene from shot to shot is done by keeping track of the characters positions and the sides of the frame they are on. The number of primary characters in each shot (primary being determined by amount of dialog, frequency of dialog, frequency referenced by text in scene) assists in determining placement of the characters or props. If only one character is in frame, the character may be positioned on one side of the frame and may face forward. If more than one person is in frame, the characters may be positioned to face towards the center of the frame or towards other characters along the stageline. Characters on the left typically face right; characters on the right typically face left. For three or more characters, the characters may be adjusted (sized smaller) and arranged to positions between the two primary characters. The facing of characters may be varied in several cinematic appropriate ways according to frame aspect ratio, intimacy of content, etc. The edges of the frame may be used to calculate object position, layering, rotating and sizing objects into the frame. The characters may be sized using the top frame edge and given specific zoom reduction to allow for specified headroom for the appropriate frame aspect ratio.

Several other cinematic conventions can be employed. The cinematic frame arrangement module 345 may resolve editorial conflicts by inserting a cutaway or close-up shot. The cinematic frame arrangement module 345 may review data about the previous shot to preserve continuity in much the same way as an editor arranges and juxtaposes shots for narrative cinematic projects. The cinematic frame arrangement module 345 may position objects and arrows appropriately to indicate movement of characters or elements in the frame or to indicate camera movement. The cinematic frame arrangement module 345 may layer elements, position elements, zoom into elements, move elements through time, add lip sync movement to characters, etc. according to their importance in the sequence structure. The cinematic frame arrangement module 345 may adjust the background to the right or left to simulate a change in view across the stageline between frames, matching the characters variation of shot sizes. The cinematic frame arrangement module 345 may accomplish background adjustments by zooming and moving the background image.

The cinematic frame arrangement module 345 may select from various shot-types. For example, the cinematic frame arrangement module 345 may create an over-the-shoulder shot-type. When it is determined that two or more characters are having a dialogue in a scene, the cinematic frame arrangement module 345 may call for an over-the-shoulder sequence. The cinematic frame arrangement module 345 may use an over-the-shoulder shot for the first speaker and the reverse-angle over-the-shoulder shot for the second speaker in the scene. As dialogue continues, the cinematic frame arrangement module 345 may repeat these shots until the scene calls for close-ups or new characters enter the scene.

The cinematic frame arrangement module 345 may select a close-up shot type. The cinematic frame arrangement module 345 may select a close-up shot type based on camera instructions (if reading text from a screenplay), the length and intensity of the dialogue, etc. The cinematic frame arrangement module 345 may determine dialogue to be intense based on keywords in parentheticals (actor instructions within text in a screenplay), punctuations in the text, length of dialogue scenes, the number of words exchanged in a lengthy scene, etc.

In one embodiment, the cinematic frame arrangement module 345 may attach accompanying sound (speech, effects and music) to each frame.

The playback module 350 includes hardware, software and/or firmware that enables playback of the cinematic shots. In one embodiment, the playback module 350 may employ in-frame motion and pan/zoom intra-frame or inter-frame movement. The playback module 350 may convert the text to a .wav file (e.g., using text to speech), which it can use to dictate the length of time that the frame (or a set of frames) will be displayed during runtime playback.

FIG. 4 is a block diagram illustrating details of the segment analysis module 335, in accordance with an embodiment of the present invention. Segment analysis module 335 includes a character analysis module 405, a slug line analysis module 410, an action analysis module 415, a key object analysis module 420, an environment analysis module 425, a caption analysis module 430 and/or other modules.

The character analysis module 405 reviews each segment of text for characters in the frame. The character analysis module 405 uses a character name dictionary to search the segment of text for possible character names. The character name dictionary may include conventional names and/or names customized by the user. The character analysis module 405 may use a generic character identifier dictionary to search the segment of text for possible generic character identifiers (such as gender words), e.g., “Lady #1,” “Boy #2,” “policeman,” etc. The segment analysis module 335 may use a generic object for rendering an object currently unassigned. For example, if the object is “policeman #1,” then the segment analysis module 335 may select a first generic graphical rendering of a policeman to be associated with policeman #1.

The character analysis module 405 may review past and/or future segments of text to determine if other characters, possibly not participating in this segment, appear to be in this frame. The character analysis module 405 may look for keywords, scene changes, parentheticals, slug lines, etc. that indicate whether a character is still in, has always been in, or is no longer in the scene. In one embodiment, unless the character analysis module 405 determines that a character from a previous frame has left before this segment, the character analysis module 405 may assume that those characters are still in the frame. Similarly, the character analysis module 405 may determine that a character in a future segment that never entered the frame must have always been there.

Upon detecting a new character, the character analysis module 405 may select one of the graphical renderings in the library 325 to associate with the new character. The selected character may be a generic character of the same gender, approximate age, approximate ethnicity, etc. If customized, the association may already exist. The character analysis module 405 stores the characters (whether by name, by generic character identifiers, by link etc.) in the frame array memory 340.

The slug line analysis module 410 reviews the segment of text for slug lines. For example, the slug line analysis module 410 looks for specific keywords, such as “INT” or “EXT” as evidence that a slug lines follows. Upon identifying a slug line, the slug line analysis module 410 uses a slug line dictionary to search the text for environment, time or other scene information. The slug line analysis module 410 may use a heuristic approach, removing one word at a time from the slug line to attempt to recognize keywords and/or phrases, e.g., fragments, in the slug line dictionary. Upon recognizing a word or phrase, The slug line analysis module 410 associates the detected background or scene object with the frame and stores the slug line information in the frame array memory 340.

The action analysis module 415 reviews the segment of text for action events. For example, the action analysis module 415 uses an action dictionary to search for action words, e.g., keywords such as verbs, sounds, cues, parentheticals, etc. Upon detection an action event, the action analysis module 415 attempts to link the action to a character and/or object, e.g., by determining the subject character performing the action or object the action is being performed upon. In one embodiment, if the text indicates that “Bob sits on the chair,” then the action analysis module 415 learns that an action of sitting is occurring, that Bob is the probable performer of the action, and that the setting is on the chair. The action analysis module 415 may use a heuristic approach, removing one word at a time from the segment of text to attempt to recognize keywords and/or phrases, e.g., fragments, in the action dictionary. The action analysis module 415 then stores the action information and possible character/object associations in the frame array memory 340.

The key object analysis module 420 searches the segment of text for key objects, e.g., props, in the frame. In one embodiment, the key object analysis module 420 uses a key object dictionary to search for key objects in the segment of text. For example, if the text segment indicates that “Bob sits on the chair,” then the key object analysis module 420 determines that a key object exists, namely, a chair. Then, the key object analysis module 420 attempts to associate that key object with its position, action, etc. In this example, it determines that the chair is currently being sat upon by Bob. The key object analysis module 420 may use a heuristic approach, removing one word at a time from the segment of text to attempt to recognize keywords and/or phrases, e.g., fragments, in the key objects dictionary. The key object analysis module 420 stores the key object information and/or the associations with the character and/or object in the frame array memory 340.

The environment analysis module 425 searches the segment of text for environment information, assuming that the environment has not been determined by, for example, the slug line analysis module 410. The environment analysis module 425 may review slug line information determined by the slug line analysis module 410, action information determined by the action analysis module 415, key object information determined by the key object analysis module 420, and may use an environment dictionary to perform independent searches for environment information. The environment analysis module 410 may use a heuristic approach, removing one word at a time from the segment of text to attempt to recognize keywords and/or phrases, e.g., fragments, in the environment dictionary. The environment analysis module 420 stores the environment information in the frame array memory 340.

The caption analysis module 430 searches the segment of text for caption information. For example, the caption analysis module 430 may identify each of the characters, each of the key objects, each of the actions, and/or the environment information to generate the caption information. For example, if Bob and Sue are having a conversation about baseball in a dentist's office, in which Bob is doing most of the talking, the caption analysis module 430 may generate a caption such as “While at the dentist office, Bob tells Sue his thoughts on baseball.” The caption may include the entire segment of text, a portion of the segment of text, or multiple segments of text. The caption analysis module 430 stores the potential caption information in the frame array memory 340.

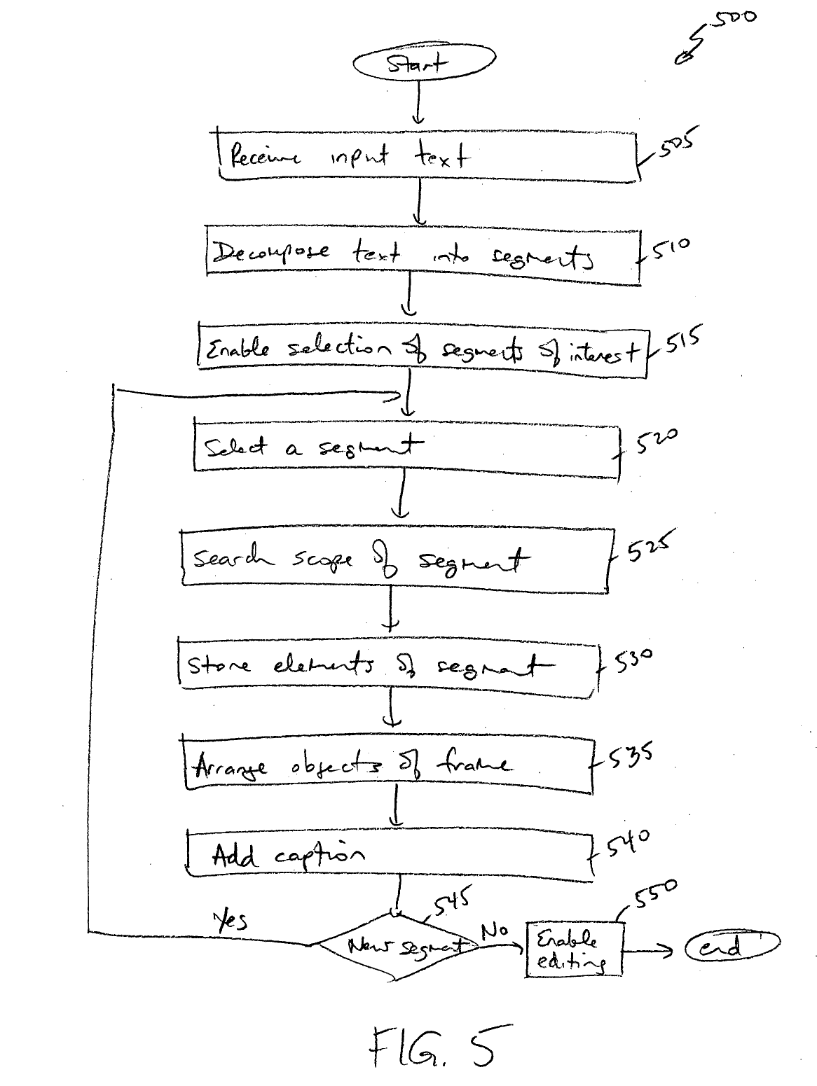

FIG. 5 is a flowchart illustrating a method 500 of converting text to cinematic images, in accordance with an embodiment of the present invention. The method 500 begins in step 505 by the input device 110 receiving input natural language text. In step 510, the text decomposition module 315 decomposes the text into segments. The segments of interest selection module 320 in step 515 enables the user to select a set of segments of interest for frame creation. The segments of interest selection module 320 may display the results to the user, and ask the user for start and stop scene numbers. In one embodiment, the user may be given a range of numbers (from x to n: the number of scene found during the first analysis of the text) and location names if available. The user may enter the range numbers of interest for the scenes they want to create frames and/or shots.

The segment analysis module 335 in step 520 selects a segment of interest for analysis and in step 525 searches the selected segment for elements (e.g., objects, actions, importance, etc.). The segment analysis module 335 in step 530 stores the noted elements in frame array memory 340. The cinematic frame arrangement module 345 in step 535 arranges the objects according to cinematic conventions, e.g., proxemics, into the frame and in step 540 adds the caption. The cinematic frame arrangement module 345 makes adjustments to each frame to create the appropriate cinematic compositions of the shot-types and shot combinations: sizing of the characters (e.g., full shot, close-up, medium shot, etc.); rotation and poses of the characters or objects (e.g., character facing forward, facing right or left, showing a character's back or front, etc.); placement, space between the elements based on proxemic patterns and cinematic compositional conventions; making and implementing decisions about stageline positions and other cinematic placement that the text may indicate overtly or though searching and cinematic analysis of the text; etc. In step 545, the segment analysis module 335 determines if there is another segment for review. If so, then method 500 returns to step 520. Otherwise, the user interface 305 enables editing, e.g., substitutions locally/globally, modifications to the graphical renderings, modification the captions, etc. The user interface 305 may enable the user to continue with more segments of interest or to redo the frame creation process. Method 500 then ends.

Looking to the script text 700 of FIG. 7 as an example, the input device 110 receiving script text 700 as input. The text decomposition module 315 decomposes the text 700 into segments. The segments of interest selection module 320 enables the user to select a set of segments of interest for frame creation, e.g., the entire script text 700. The segment analysis module 335 selects the first segment (the slug line) for analysis and searches the selected segment for elements (e.g., objects, actions, importance, etc.). The segment analysis module 335 recognizes the slug line keywords suggesting a new scene, and possibly recognizes the keywords of “NYC” and “daytime.” The segment analysis module 335 selects a background image from the library 325 (e.g., an image of the NYC skyline or a generic image of a city) and stores the link in frame array memory 340. Noting that the element is background information from a slug line, the cinematic frame arrangement module 345 may select an establishing shot of NYC skyline during daytime or of the generic image of the city during daytime into the frame and may possibly add the caption “NYC.” The segment analysis module 335 determines that there is another segment for review. Method 500 returns to step 520 to analyze the first scene description 710.

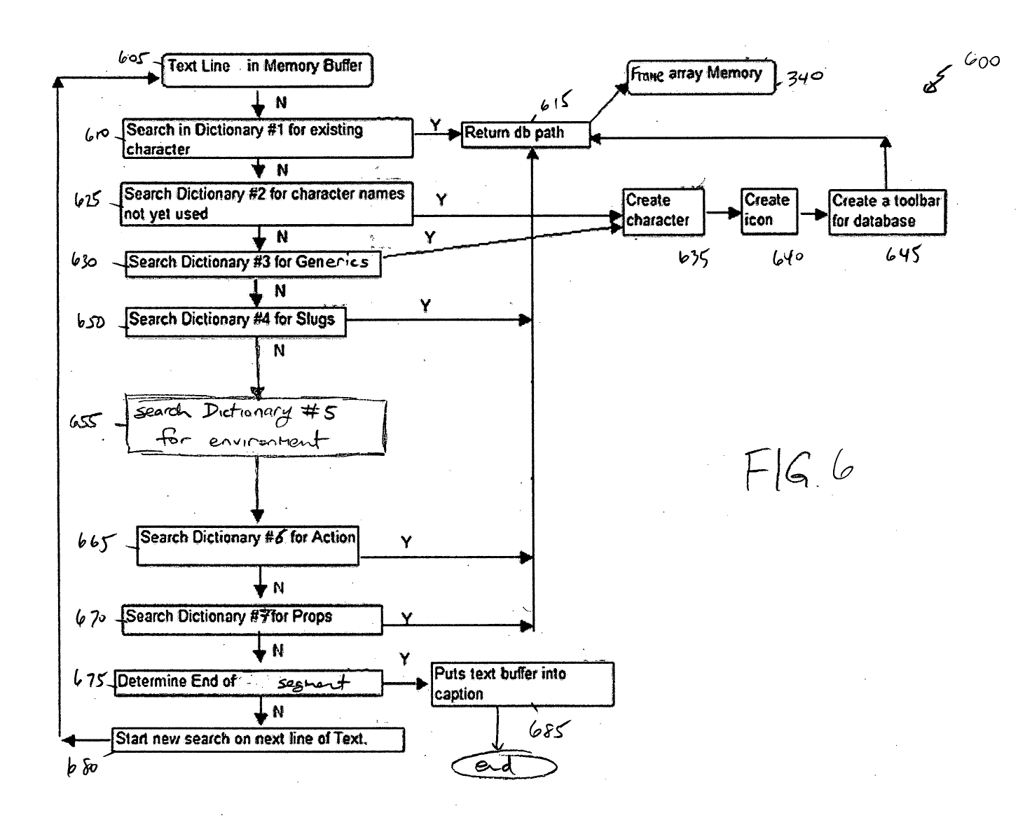

FIG. 6 is a flowchart illustrating details of a method 600 of analyzing text and generating a shot array memory 340, in accordance with an embodiment of the present invention. The method 600 begins in step 605 with the text buffer module 310 selecting a line of text, e.g., from a text buffer memory. In this embodiment, the line of text may be an entire segment or a portion of a segment. The segment analysis module 335 in step 610 uses a Dictionary #1 to determine if the line of text includes an existing character name. If a name is matched, then the segment analysis module 335 in step 615 returns the link to the graphical rendering in the library 325 and in step 620 stores the link into the frame array memory 340. If the line of text includes text other than the existing character name, the segment analysis module 335 in step 625 uses a Dictionary #2 to search the line of text for new character names. If the text line is determined to include a new character name, the segment analysis module 335 in step 635 creates a new character in the existing character Dictionary #1. The segment analysis module 335 may find a master character or a generic, unused character to associate with the name. The segment analysis module 335 in step 640 creates a character icon and in step 645 creates toolbar for the library 325. Method 600 then returns to step 615 to select and store the link in the frame array memory 340.

In step 630, if the line of text includes text other than existing and new character names, the segment analysis module 335 uses Dictionary #3 to search for generic character identifiers, e.g., gender information, to identify other possible characters. If a match is found, the method 600 jumps to step 635 to create another character to the known character Dictionary #1.

In step 650, if additional text still exists, the segment analysis module 335 uses Dictionary #4 to search the line of text for slug lines. If a match is found, the method 600 jumps to step 615 to select and store the link in the frame array memory 340. To search the slug line, the segment analysis module 335 may remove a word from the line and may search the Dictionary #4 for fragments. If determined to include a slug line but no match is found, the segment analysis module 335 may select a default background image. If a slug line is identified and a background is selected, the method 600 jumps to step 615 to select and store the link in the frame array memory 340.

In step 655, if additional text still exists, the segment analysis module 335 uses Dictionary #5 to search the line of text for environment information. If a match is found, the method 600 jumps to step 615 to select and store the link to the environment in the frame array memory 340. To search the line, the segment analysis module 335 may remove a word from the line and may search the Dictionary #5 for fragments. If no slug line was found and no match to an environment was found, the segment analysis module 335 may select a default background image. If an environment is selected, the method 600 jumps to step 615 to select and store the link in the frame array memory 340.

In step 665, the segment analysis module 335 uses Dictionary #6 to search the line of text for actions, transitions, off screen parentheticals, sounds, music cues, and other story relevant elements that may influence cinematic image placement. To search the line for actions, the segment analysis module 335 may remove a word from the line and may search Dictionary #6 for fragments. For each match found, method 600 jumps to step 615 to select and store the link in the frame array memory 340.

The segment analysis module 335 in step 670 uses Dictionary #7 to search the line of text for key objects, e.g., props, or other non-character elements known to one skilled in the cinematic industry. For every match found, the method 600 jumps to step 615 to select and store the link in the frame array memory 340.

After the segment is thoroughly analyzed, the segment analysis module 335 in step 675 determines if the line of text is the end of a segment. If it is determined not to be the end of the segment, the segment analysis module 335 returns to step 605 to begin analyzing the next line of text in the segment. If it is determined that it is the end of the segment, the segment analysis module 335 in step 680 puts a caption, e.g., the text, into the caption area for that frame. Method 600 then ends.

Looking to the script text 700 of FIG. 7 as an example, the first line (the first slug line 705) is selected in step 605. No existing characters are located in step 610. No new characters are located in step 625. No generic character identifiers are located in step 630. The line of text is noted to include a slug line in step 650. The slug line is analyzed and determined in slug line dictionary to include the term “ESTABLISH” indicating an establishing shot and to include “NYC” and “DAYTIME.” A link to a establishing shot of NYC during daytime in the library 325 is added to the frame array memory 340. Since a slug line identified environment information and/or no additional text remains, no environment analysis need by completed in step 655. No actions are located or no action analysis need be conducted (since no additional text exists) in step 665. No props are located or no prop analysis need be conducted (since no additional text exists) in step 670. The line of text is determined to be the end of the segment in step 675. A caption “NYC-Daytime” is added to the frame array memory 340. Method 600 then ends.

Repeating the method 600 for the next segment of script text 700 of FIG. 7 as another example, the first scene description 710 is selected in step 605. No existing characters are located in step 610. No new characters are located in step 625. No generic character identifiers are located in step 620. No slug line is located in step 650. Environment information is located in step 655. Matches may be found to keywords or phrases such as “cold,” “winter,” “day,” “street,” etc. The segment analysis module 335 may select an image of a cold winter day on the street from the library 325 and stores the link in the frame array memory 340. No actions are located in step 665. No props are located in step 670. The line of text is determined to be the end of the segment in step 675. The entire line of text may be added as a caption for this frame to the frame array memory 340. Method 600 then ends.

In one embodiment, the system matches the natural language text to the keywords in the dictionaries, instead of the keywords in the dictionaries to the natural language text. The libraries may include multiple databases of assets, including still images, motion picture clips, 3D models, etc. The dictionaries may directly reference these assets. Each frame may use an image as the background layer. Each frame can contain multiple images of other assets, including images of arrows to indicate movement. The assets may be sized, rotated and positioned within a frame to appropriate cinematic compositions. The series of frames may follow proper cinematic, narrative structure in terms of shot composition and editing, to convey meaning though time, and as may be indicated by the story. Cinematic compositions may be employed including long shot, medium shot, two-shot, over-the-shoulder shot, close-up shot, and extreme close-up shot. Frame composition may be selected to influence audience reaction to the frame, and may communicate meaning and emotion about the character within the frame. The system may recognize and determine the spatial relationships of the image assets within a frame and the relationship of the frame-to-frame juxtaposition. The spatial relationships may be related to the cinematic frame composition and the frame-to-frame juxtaposition. The system may enable the user to move, re-size, rotate, edit, and layer the assets within the frame, to edit the order of the frames, and to allow for insertion and deletion of additional frames. The system may enable the user to substitute an asset and make a global change over the series of frames contained in the project. The assets may be stored by name, size and position in each frame, thus allowing the substituted object to appropriate the size and placement of the original object. The system may enable printing the frames on paper. The system may include the text associated with the frame to be printed if so desired by the user. The system may enable outputting the frame to a single image file that maintains the layered characteristics of the assets within the shot or frame. The system may associate sound with the frame. The system may include a text-to-speech engine to create the sound track to the digital motion picture. The system may include independent motion of objects within the frame. The system may include movement of characters to lip sync the text to speech sounds. The sound track to an individual frame may determine the time length of the individual frame within the context of the digital motion picture. The digital motion picture may be made up of clips. Each individual clip may be a digital motion picture file that contains the soundtrack and composite image that the frame or shot represents, and a data file containing information about the assets of clip. The system may enable digital motion picture output to be imported into a digital video-editing program, wherein the digital motion picture may be further edited in accordance with film industry standards. The digital motion picture may convey a story and emotion representative of a narrative, motion picture film or video.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A system comprising:
an input device for receiving input text;
a text decomposition module for decomposing the input text into segments;
a segment analysis module for using a dictionary to identify at least one object in one of the segments for inclusion in a frame; and
a cinematic frame arrangement module for using cinematic conventions to arrange the at least one object in the frame.

2. The system of claim 1, wherein the input device includes a keyboard.

3. The system of claim 1, wherein the input device includes a disk drive.

4. The system of claim 1, wherein the input device includes a network interface.

5. The system of claim 1, wherein the text decomposition module decomposes the input text into single line segments.

6. The system of claim 1, wherein the dictionary includes a slug line dictionary and the at least one object includes environment information.

7. The system of claim 1, wherein the dictionary includes a character dictionary and the at least one object includes a character.

8. The system of claim 1, wherein the dictionary includes a prop dictionary and the at least one object includes a prop.

9. The system of claim 1, wherein the segment analysis module determines the relative importance of the at least one object, and the cinematic frame arrangement module positions the at least one object based on its relative importance.

10. The system of claim 1, wherein the segment analysis module reviews a segment adjacent to the one of the segments to determine relevant objects for the one of the segments.

11. A method comprising:
receiving input text;
decomposing the input text into segments;
using a dictionary to identify at least one object in one of the segments for inclusion in a frame; and
using cinematic conventions to arrange the at least one object in the frame.

12. The method of claim 11, wherein the input text is received via a keyboard.

13. The method of claim 11, wherein the input text is received via a disk drive.

14. The method of claim 11, wherein the input text is received via a network interface.

15. The method of claim 11, wherein the segments includes single line segments.

16. The method of claim 11, wherein the dictionary includes a slug line dictionary and the at least one object includes environment information.

17. The method of claim 11, wherein the dictionary includes a character dictionary and the at least one object includes a character.

18. The method of claim 11, wherein the dictionary includes a prop dictionary and the at least one object includes a prop.

19. The method of claim 11, further comprising determining the relative importance of the at least one object, and positioning the at least one object in the frame based on its relative importance.

20. The method of claim 11, further comprising analyzing a segment adjacent to the one of the segments to determine relevant objects for the one of the segments.

21. A system comprising:
means for receiving input text;
means for decomposing the input text into segments;
means for using a dictionary to identify at least one object in one of the segments for inclusion in a frame; and
means for using cinematic conventions to arrange the at least one object in the frame.
